(19) United States
(12) Patent Application Publication
(10) Pub. No.: US 2025/0226466 A1
(43) Pub. Date: Jul. 10, 2025

(54) PRESSURE-MONITORING FOR ELECTROCHEMICAL CELLS AND RELATED DEVICES AND SYSTEMS

(71) Applicant: Sion Power Corporation, Tucson, AZ (US)

(72) Inventors: Jared M. Jennings, Tucson, AZ (US); Bryce Yazzie, Marana, AZ (US); Joselyn Bock, Oro Valley, AZ (US); James Anthony Bock, Oro Valley, AZ (US)

(73) Assignee: Sion Power Corporation, Tucson, AZ (US)

(21) Appl. No.: 18/847,510

(22) PCT Filed: Mar. 16, 2023
(86) PCT No.: PCT/US2023/015355

§ 371 Date: Sep. 16, 2024

Related U.S. Application Data
(60) Provisional application No. 63/320,955, filed on Mar. 17, 2022.

(51) Int. Cl. H01M 10/48; G01L 1/22; H01M 10/42; H01M 10/44

(52) U.S. Cl. CPC H01M 10/48; G01L 1/225; H01M 10/4257; H01M 10/445; H01M 2010/4278; H01M 2200/20

(57) ABSTRACT

Systems and methods for measuring pressure applied to electrochemical cells are generally described. In some aspects, electrochemical devices including an electrochemical cell and an associated sensor are provided. The sensor may be configured to produce a signal indicative of the pressure experienced by the electrochemical cell. In some instances, the sensor measures the applied pressure by being responsive to displacement of load-bearing components of the electrochemical device. Such a configuration may permit the sensor to accurately measure the pressure at the cell while being positioned adjacent to an electrochemical device housing component rather than overlapping with the cell itself. For example, in some embodiments a strain gauge adjacent to a load-bearing member of an electrochemical device housing such as a housing fastener or frame component is employed to measure cell pressure.

### RELATED APPLICATIONS

This application claims priority under 35 U.S.C. § 119 (e) to U.S. Provisional Patent Application No. 63/320,955, filed Mar. 17, 2022, and entitled, “Pressure-Monitoring For Electrochemical Cells and Related Devices and Systems,” which is incorporated herein by reference in its entirety for all purposes.

### TECHNICAL FIELD

Systems and methods for measuring pressure applied to electrochemical cells are generally described.

### BACKGROUND

Batteries typically include one or more cells that undergo electrochemical reactions to produce electric current. Applying a force to at least a portion of an electrochemical cell (e.g., during cycling of the cell) can improve the performance of the electrochemical cell. Certain embodiments of the present disclosure are directed to inventive articles, systems, and methods relating to the measuring and/or handling of compressive force in batteries.

### SUMMARY

Systems and methods for measuring pressure applied to electrochemical cells are generally described. The subject matter of the present invention involves, in some cases, interrelated products, alternative solutions to a particular problem, and/or a plurality of different uses of one or more systems and/or articles.

In one aspect, electrochemical devices are provided. In some embodiments, the electrochemical device comprises an electrochemical cell; a housing at least partially enclosing the electrochemical cell, wherein the housing is configured to apply, via tension in a load-bearing housing member, during at least one period of time during charge and/or discharge of the electrochemical cell, an anisotropic force with a component normal to an electrode surface of the electrochemical cell; and a sensor adjacent to the load-bearing housing member and configured to produce a signal indicative of a pressure experienced by the electrochemical cell.

In another aspect, systems are provided. In some embodiments, the system comprises an electrochemical cell; a housing at least partially enclosing the electrochemical cell, wherein the housing is configured to apply, during at least one period of time during charge and/or discharge of the electrochemical cell, an anisotropic force with a component normal to an electrode surface of the electrochemical cell; a sensor configured to produce a signal; and a control system configured to receive the signal produced by the sensor, the control system comprising one or more processors programmed to: determine a measure indicative of the pressure experienced by the electrochemical cell based at least in part on the signal produced by the sensor; and produce a signal indicative of a condition of the electrochemical cell based at least in part on whether the measure indicative of the pressure experienced by the electrochemical cell is greater than an upper threshold value or less than a lower threshold value.

In another aspect, methods are provided. In some embodiments, the method comprises: applying, during at least one period of time during charge and/or discharge of an electrochemical cell, an anisotropic force with a component normal to an electrode surface of the electrochemical cell; determining, during at least a portion of the applying step, a measure indicative of a pressure experienced by the electrochemical cell; and producing a signal indicative of a condition of the electrochemical cell based at least in part on the measure indicative of the pressure experienced by the electrochemical cell.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B show cross-sectional schematic diagrams of electrochemical devices comprising an electrochemical cell, a housing, and a sensor, according to some embodiments;

FIG. 1C shows a cross-sectional schematic diagram of an electrochemical device comprising a stack of electrochemical cells, a housing, and a sensor, according to some embodiments;

FIG. 1D shows a cross-sectional schematic diagram of an electrochemical device comprising a stack of electrochemical cells, a housing, and a sensor, according to some embodiments;

FIG. 2 shows a cross-sectional schematic diagram of an electrochemical cell, according to some embodiments;

FIG. 3A shows a top-view schematic illustration of a sensor in the form of a strain gauge, according to some embodiments;

FIG. 3B shows a circuit diagram of a circuit for determining an electrical signal, according to some embodiments;

FIG. 4 shows a cross-sectional schematic diagram of an electrochemical device comprising electrochemical cells, a housing, and a sensor, according to some embodiments;

FIG. 5 shows a cross-sectional schematic diagram of an electrochemical device comprising electrochemical cells, a housing, and a sensor, according to some embodiments;

FIG. 6A shows a cross-sectional schematic diagram of an electrochemical device comprising an electrochemical cell, a housing, and a sensor overlapping the electrochemical cell, according to some embodiments;

FIG. 6B shows a cross-sectional schematic diagram of an electrochemical device comprising a stack of electrochemical cells, a housing, and a sensor overlapping the electrochemical cells, according to some embodiments;

FIG. 7 shows a cross-sectional schematic diagram of a system comprising an electrochemical device comprising an electrochemical cell, a housing, and a sensor, and also comprising a control system, according to some embodiments;

FIG. 8 shows a cross sectional schematic diagram of an electric vehicle comprising an electrochemical device, according to some embodiments;

FIG. 9 shows a plot of measured force on a load-bearing housing member versus load step for a pressure testing system and a strain gauge, according to some embodiments;

FIG. 10 shows an image of a load-bearing housing component coupled to a sensor in the form of a strain gauge and being tested by an external pressure testing system, according to some embodiments;

FIGS. 11-12 shows a plot of measured force and elongation of a load-bearing housing member for a pressure testing system (FIG. 11) and a strain gauge (FIG. 12), according to some embodiments; and

FIG. 13 shows a plot of active area pressure and electrochemical device voltage versus time, according to some embodiments.

### DETAILED DESCRIPTION

Systems and methods for measuring pressure applied to electrochemical cells are generally described. In some aspects, electrochemical devices including an electrochemical cell and an associated sensor are provided. The pressure sensor may be configured to produce a signal indicative of the pressure experienced by the electrochemical cell (e.g., the pressure experienced by an electrode surface of the electrochemical cell). In some instances, the sensor measures the applied pressure by being responsive to displacement of load-bearing components of the electrochemical device. Such a configuration may permit the sensor to accurately measure the pressure at the cell while being positioned adjacent to an electrochemical device housing component rather than overlapping with the cell itself. For example, in some embodiments a strain gauge adjacent to a load-bearing member of an electrochemical device housing such as a housing fastener or frame component is employed to measure cell pressure.

Additionally, certain of the systems and methods described in this disclosure provide for ways to monitor the condition of one or more electrochemical cells in an electrochemical device based on signals produced by a sensor. The condition of the electrochemical cells, such as their health and/or safety, may be determined based on measurements of applied pressure experienced by the cells (e.g., during charging and/or discharging). For example, a system comprising the electrochemical device, a sensor, and a control system configured to receive signals from the sensor may be provided. The control system may produce a signal indicative of the condition of the electrochemical cell such that a user can monitor the condition and/or such that one or more operational parameters of the electrochemical device (e.g., charging/discharging and/or applied pressure) can be modulated manually or automatically.

In some cases, it may be beneficial to apply force to an electrochemical cell in an electrochemical device. For example, in some cases applying an anisotropic force with a component normal to an electrode surface (e.g., an electrode active surface) of at least one of the electrochemical cells can improve performance during charging and/or discharging by reducing problems such as dendrite formation and surface roughening of the electrode while improving current density. One such example is the case where at least one of the electrochemical cells of the electrochemical device comprises lithium metal or a lithium metal alloy as an electrode active material during at least a portion of a charge/discharge cycle. Lithium metal may undergo dendrite growth, for example, which can in certain cases lead to failure of the electrochemical cell and safety hazards. Application of an anisotropic force to electrodes comprising lithium metal may mitigate lithium dendrite formation and other deleterious phenomena. In some instances it is desirable to have real-time monitoring of the pressure experienced by the electrochemical cells (e.g., in the intact, assembled electrochemical device such as during charging and/or discharging). Such monitoring may be useful to evaluate the health of the electrochemical device throughout its life cycle and/or to induce any needed adjustments the electrochemical device's operation. However, certain systems used for monitoring pressure at electrochemical cells can provide drawbacks. For example, external pressure testing systems such as Instron® load frames are bulky and expensive and not suitable for real-time monitoring of electrochemical devices outside of laboratory settings (e.g., when being used in realistic conditions such as in electric vehicles). As another example, pressure arrays such as Tekscan scanners, while integrable with electrochemical device stacks in assembled electrochemical devices, may suffer from drift and may not provide sufficient accuracy or precision for detecting small pressure variations that could be indicative of electrochemical device health issues. It has been realized in the context of the present disclosure that certain sensors can be integrated with electrochemical devices without some or all of these drawbacks. For example, it has been realized that sensors such as strain gauges coupled to load-bearing members of an electrochemical device's housing can accurately measure cell pressure while being inexpensive and readily integrable with an assembled electrochemical device.

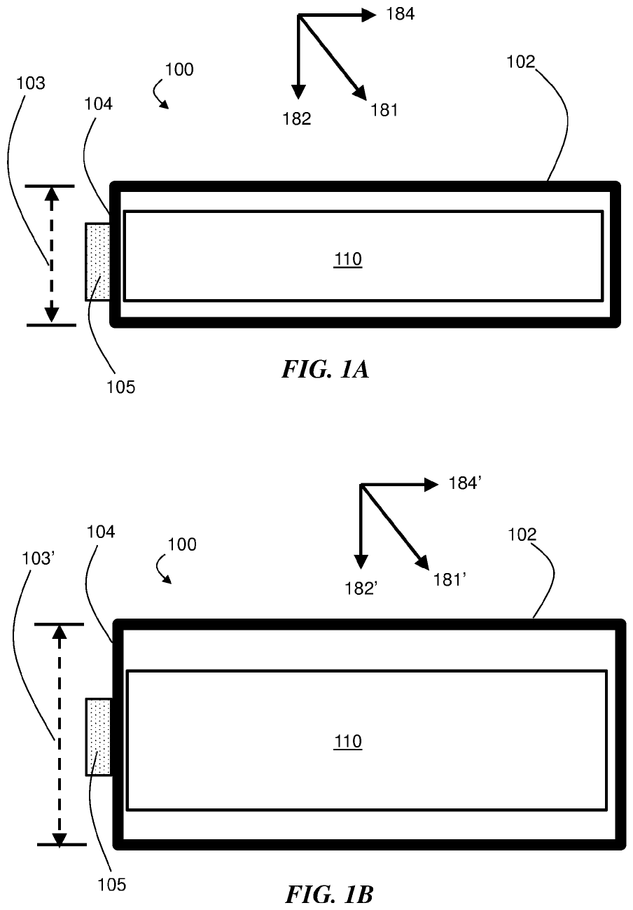

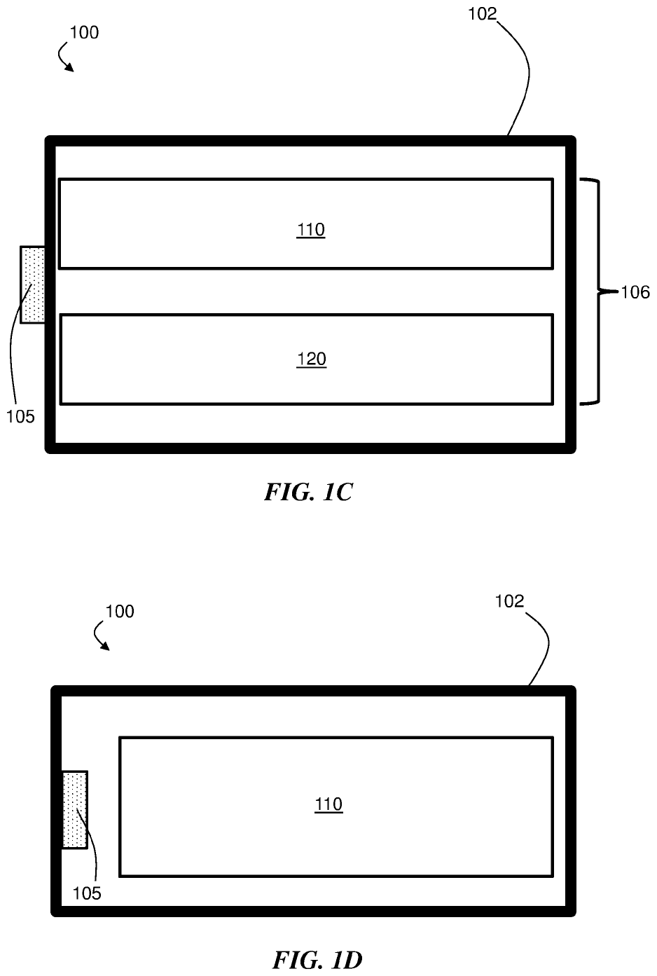

In one aspect, electrochemical devices are generally described. FIGS. 1A-1B are cross-sectional schematic diagrams of one embodiment of electrochemical device 100. The electrochemical device may comprise one or more electrochemical cells as well as one or more other components (e.g., articles stacked with the electrochemical cell(s), housings, electrochemical device control systems, electrical and thermal management equipment, etc.). In some embodiments, the electrochemical device comprises an electrochemical cell. For example, electrochemical device 100 in FIGS. 1A-1B comprises electrochemical cell 110 at least partially enclosed by housing 102 associated with sensor 105, described in more detail below. The electrochemical device may have any of a variety of suitable configurations including, but not limited to, a stacked configuration, a folded configuration, or a wound configuration. In some embodiments, at least one electrode of an electrochemical cell in the electrochemical device comprises lithium metal and/or a lithium metal alloy as an electrode active material during at least a portion of a charge/discharge cycle. For example, at least one electrode of electrochemical cell 110 may comprise lithium metal and/or a lithium metal alloy as an electrode active material during at least a portion of a charge/discharge cycle of electrochemical device 100.

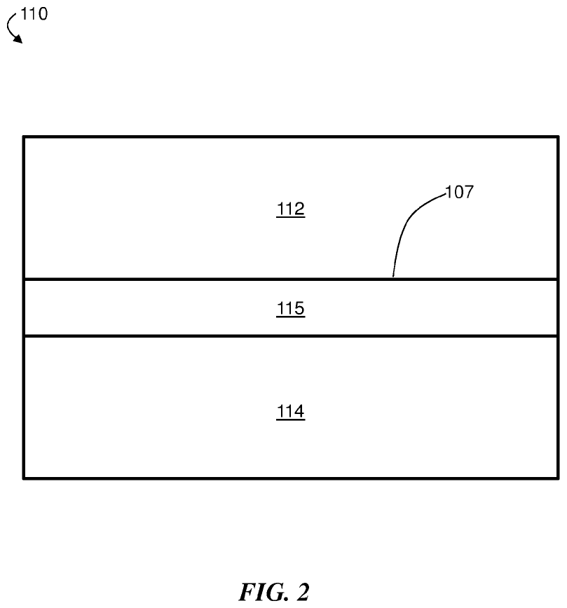

In some embodiments, an electrochemical cell in the electrochemical device comprises an anode. FIG. 2 shows a cross-sectional schematic diagram of one example of an embodiment of electrochemical cell 110 comprising anode 112. The anode can comprise an anode active material. As used herein, an “anode active material” refers to any electrochemically active species associated with an anode. In some embodiments, the anode comprises lithium metal and/or a lithium metal alloy as an anode active material during at least a portion of a charge/discharge cycle. For example, referring again to FIG. 2, anode 112 comprises lithium metal and/or a lithium metal alloy as an anode active material in some embodiments. In certain cases, the anode is or comprises vapor-deposited lithium (e.g., a vapor-deposited lithium film). Additional examples of suitable anode active materials are described in more detail below. Certain embodiments described herein may be directed to systems, devices, and methods that may allow for improved monitoring and/or operation of electrochemical devices comprising certain anodes, such as lithium metal-containing anodes. For example, certain embodiments may allow for improved monitoring of pressures resulting from applied force, which can vary in some instances on the state of charge of the electrochemical cell and/or the health of the electrochemical cell.

In some embodiments, an electrochemical cell in the electrochemical device comprises a cathode. For example, referring again to FIG. 2, electrochemical cell 110 comprises cathode 114. The cathode can comprise a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, cathode 114 in FIG. 2 comprises a nickel-cobalt-manganese lithium intercalation compound. Additional examples of suitable cathode materials are described in more detail below.

As used herein, “cathode” refers to the electrode in which an electrode active material is oxidized during charging and reduced during discharging, and “anode” refers to the electrode in which an electrode active material is reduced during charging and oxidized during discharging.

In some embodiments, an electrochemical cell in the electrochemical device comprises a separator between the anode and the cathode. FIG. 2 shows separator 115 between anode 112 and cathode 114, according to certain embodiments. The separator may be a solid electronically non-conductive or insulative material that separates or insulates the anode and the cathode from each other, preventing short circuiting, and that permits the transport of ions between the anode and the cathode. In some embodiments, the separator is porous and may be permeable to an electrolyte. In certain embodiments, the separator is a solid electrolyte that permits transport of ions between the anode and the cathode while inhibiting transport of electrons between the anode and the cathode.

While a single electrochemical cell is illustrated in the electrochemical devices shown in FIGS. 1A-1B, the electrochemical device is not limited to having a single electrochemical cell. In some embodiments, the electrochemical device comprises multiple electrochemical cells. In some embodiments, the electrochemical device is part of a battery (e.g., a rechargeable battery) having multiple electrochemical cells. In some embodiments, the electrochemical device (e.g., battery) comprises a first electrochemical cell and a second electrochemical. Electrochemical device 100 in FIG. 1C, for example, shows electrochemical device 100 comprising first electrochemical cell 110 and second electrochemical cell 120. It should be understood that while in some embodiments the first electrochemical cell and the second electrochemical cell have the same types of components (e.g., same anode active material, same cathode active material, same type of separator), in other embodiments the first electrochemical cell has one or more different components than the second electrochemical cell (e.g., a different anode active material, a different cathode active material, a different type of separator). In some embodiments, the first electrochemical cell and the second electrochemical cell are identical in composition and/or dimensions. In some embodiments, the cells of the electrochemical device (e.g., battery) are arranged in an electrical circuit in parallel, in series, or a combination thereof. In some embodiments, the electrochemical device comprises a stack comprising electrochemical cells (e.g., the first electrochemical cell, the second electrochemical cell). It should be understood that the stack may be a multicomponent stack comprising non-cell components such as thermally insulating compressible solid article portions (e.g., thermally insulating foam such as microcellular polyurethane foam), thermally conductive solid article portions (e.g., metal or metal alloy fins such as aluminum fins), and/or sensors (e.g., pressure sensors).

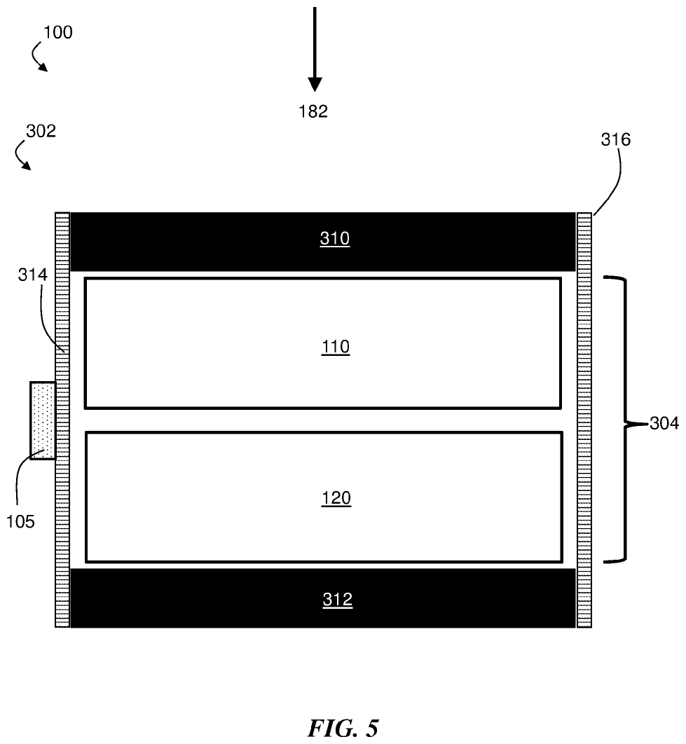

Some aspects of the present disclosure relate to applying an anisotropic force with a component normal to an electrode surface (e.g., an electrode active surface) of an electrochemical cell. In some such cases, the anisotropic force is applied to the electrochemical cell during at least one period of time during charge and/or discharge of the electrochemical cell. In some embodiments, the anisotropic force is applied to the electrochemical cell during an entirety of a charge/discharge cycle of the electrochemical cell. An ability to effectively measure the magnitude of (and/or changes in) pressure experienced by the electrochemical cell as a result of applied forces during cycling may present certain challenges, including accuracy, cost, and case of integration of pressure-measuring devices into assembled electrochemical devices. Certain aspects described in this disclosure directed to sensors and related systems may, in some cases, address and overcome such challenges. Some embodiments comprise applying an anisotropic force with a component normal to an electrode surface of the electrochemical cell defining a pressure of at least 3 kg_{f}/cm², at least 5 kg_{f}/cm², at least 10 kg_{f}/cm², at least 12 kg_{f}/cm², at least 20 kg_{f}/cm², at least 25 kg_{f}/cm², and/or up to 30 kg_{f}/cm², up to 35 kg_{f}/cm², up to 40 kg_{f}/cm², or more. Combinations of these ranges (e.g., at least 3 kg_{f}/cm² and less than or equal to 25 kg_{f}/cm², at least 3 kg_{f}/cm² and less than or equal to 15 kg_{f}/cm², at least 10 kg_{f}/cm² and less than or equal to 40 kg_{f}/cm², or at least 12 kg_{f}/cm² and less than or equal to 30 kg_{f}/cm²) are possible. In some embodiments, an anisotropic force with a component normal to an electrode surface of the electrochemical cell defining a pressure in one of the aforementioned ranges is applied, where the electrode surface is an electrode active surface. In some embodiments, an anisotropic force with a component normal to a surface of an electrode of the electrochemical cell defining a pressure in one of the aforementioned ranges is applied, where the surface of the electrode of the electrochemical cell comprises metallic lithium (e.g., lithium metal and/or a metal alloy comprising lithium). In some embodiments, an anisotropic force with a component normal to an electrode surface of the electrochemical cell defining a pressure in one of the aforementioned ranges is applied, where the electrode surface of the electrochemical cell is facing an electrode of the electrochemical having an opposite polarity (e.g., the anisotropic force has a component normal to a surface of an anode facing a cathode of the cell, or the anisotropic force has a component normal to a surface of a cathode facing an anode of the cell). In some embodiments where the electrochemical cell is part of a stack of cells, an anisotropic force with a component normal to a lateral surface of the stack (corresponding to an end of the stack rather than a side of the stack) defining a pressure in one of the aforementioned ranges is applied. In some embodiments where the electrochemical cell is part of a stack of cells, an anisotropic force with a component parallel to the direction in which the cells are stacked defining a pressure in one of the aforementioned ranges is applied. For example, in FIG. 5, force 182 is parallel to the direction in which stack 304 comprising first electrochemical cell 110 and second electrochemical cell 120 is stacked and can define a pressure in one of the aforementioned ranges. In this context, “parallel” can be within 20°, within 10°, within 5°, or within 2° of parallel.

FIG. 1A depicts a schematic illustration of a force that may be applied to electrochemical cell 110 in the direction of arrow 181, according to some embodiments. Arrow 182 illustrates the component of force 181 that is normal to an electrode surface of electrochemical cell 110, according to certain embodiments.

As mentioned above, in some embodiments, an anisotropic force is applied having a component normal to an electrode surface of the electrochemical cell, where that electrode surface is an electrode active surface. As used herein, the term “electrode active surface” is used to describe a surface of an electrode at which electrochemical reactions may take place. As one example, in embodiments in which the electrode comprises a lithium metal foil as the anode active material, the external surface of the lithium metal foil would be an active surface of the electrode. In general, the electrode active surface can be in physical contact with an electrolyte when the electrode is part of an electrochemical cell, such that the electrolyte transports ions or other non-electron electrochemically active reactants between that electrode and a counter-electrode. For example, in FIG. 2, anode 112 of electrochemical cell 110 has active surface 107.

In some embodiments, a measure indicative of the pressure experienced by the electrochemical cell is determined during at least a portion (or all) of the application of the anisotropic force with a component normal to the electrode surface (e.g., electrode active surface) of the electrochemical cell. The measure indicative of the pressure may be based on a signal or a calculated value produced by one or more devices associated with the electrochemical cell. For example, in some embodiments, the measure indicative of the pressure experienced by the electrochemical cell is based at least in part on a signal produced by a sensor associated with the electrochemical cell. The sensor may be associated with the electrochemical cell in any of a variety of manners provided that it is able to measure magnitudes and/or changes in pressure experienced by the electrochemical cell. For example, in some embodiments, the sensor is adjacent (e.g., directly adjacent or indirectly adjacent) to the electrochemical cell. In some, but not necessarily all embodiments, the sensor is directly adjacent to the electrochemical cell such that there are no intervening layers or components between the sensor and electrochemical cell. However, in other embodiments, intervening articles or layers may be present between the sensor and the electrochemical cell, such as other sensors (e.g., temperature sensors, cooling elements, spacers, etc.). In some embodiments, the sensor is adjacent to a component of the electrochemical device other than the electrochemical cell, with that other component being in direct or indirect contact with the electrochemical cell. For example, in some embodiments, the electrochemical device comprises a housing (described in more detail below) at least partially enclosing the electrochemical cell, and the electrochemical device also comprises a sensor adjacent the housing.

FIGS. 1A-1B show a cross-sectional schematic diagram of one embodiment of electrochemical device 100 comprising sensor 105 associated with the electrochemical cell 110. The sensor may be configured to produce a signal indicative of a pressure experienced by the electrochemical cell (e.g., at an electrode surface)) as a result of an applied anisotropic force having a component normal to the electrode surface of the electrochemical cell. A signal indicative of a pressure experienced by an electrochemical cell may transmit a direct measurement of the pressure or may be convertible into a measure of pressure (e.g., by conveying a value of a parameter such as force or strain that can be used to calculate pressure). The sensor may be in a position and configured such that a magnitude and/or distribution of pressure determined by the sensor is indicative of a magnitude and/or distribution of pressure experienced by the electrochemical cell. In FIG. 1A, sensor 105 is adjacent housing 102 enclosing electrochemical cell 110. In some embodiments, interaction between the electrochemical cell and the housing (e.g., during application of the anisotropic force) can, in turn affect the measurements taken by the sensor.

In some embodiments, the sensor is configured to produce a signal. The signal may take any of a variety of forms provided that the signal can be used to directly or indirectly obtain pressure measurements related to the electrochemical device. For example, the sensor may produce an electrical signal, an optical signal, a magnetic signal, and/or a thermal signal indicative of a pressure reading. In some embodiments, the signal produced by the sensor is indicative of the pressure experienced by the electrochemical cell (e.g., at an electrode surface). The pressure experienced by the electrochemical cell measured by the sensor may be the pressure defined by the applied anisotropic force (e.g., defined by the component of the anisotropic force that is normal to an active surface of an electrode of the electrochemical cell). For example, in some embodiments, the signal produced by the sensor can be directly or indirectly converted into a measure of the pressure experienced by an electrode surface (e.g., an electrode active surface such as an anode active surface) of the electrochemical cell during application of the anisotropic force. In some embodiments, the sensor directly measures pressure and produces a direct pressure measurement signal. In some embodiments, the sensor indirectly measures pressure. For example, in some embodiments, the pressure sensor indirectly measures the pressure experienced by the electrochemical cell (e.g., at an electrode surface) by producing a signal that is not a direct pressure measurement, but is instead a signal corresponding to a parameter (e.g., voltage, resistance, force or strain at the electrochemical cell or at a component other than the electrochemical cell) that can be used to calculate the pressure experienced by the electrochemical cell (e.g., based on the geometry of the electrochemical device and its components).

As noted above, in some embodiments, the signal produced by the sensor may be an electrical signal. For example, in some embodiments, the signal produced by the sensor is based on a measured voltage (e.g., a voltage output from the sensor). In some embodiments, the signal produced by the sensor is based on a measured resistance (e.g., a resistance measurement in an electrical circuit involving the sensor). In some embodiments, the signal produced by the sensor is based on a measured current (e.g., an electrical current measurement in an electrical circuit involving the sensor).

Any of a variety of suitable sensors may be employed. The sensor may be chosen based on expected magnitudes of pressure, desired pressure resolution (both in terms of magnitude or spatial distribution), desired accuracy, case of integration with the electrochemical device, cost, and/or desired dimensions (e.g., compatible with dimensions of the electrochemical device). In some embodiments, the sensor is a resistive sensor. Non-limiting examples of resistive sensors include strain gauges and piezoresistive sensors. In some embodiments, the sensor is a capacitance-based sensor. One example of a capacitance-based sensor is one comprising two electrodes with an electrically insulative material between the two electrodes. The electrically insulative material may have a known dielectric constant. In certain cases, the electrically insulative material is configured such that the force applied to the capacitive-based sensor comprising the two electrodes in the electrically insulative material causes the thickness of the electrically insulative material to change, thereby varying a measured capacitance between the two electrodes. For example, in some cases, the electrically insulative material between the two electrodes is a polymeric material. The polymeric material may be relatively soft and have a known dielectric constant. In some embodiments, the sensor is a piezoelectric sensor. Piezoelectric and piezoresistive sensors typically comprise piezoelectric or piezoresistive materials coupled to an external electrical circuit capable of detecting and measuring change in electric charge or resistance upon mechanical deformation of the materials. In some embodiments, the sensor comprises a pressure foam. In some embodiments, the sensor comprises a load cell. For example, in some embodiments where a rod is a load-bearing housing member, a donut load cell can be coupled to the rod. In some embodiments, the sensor comprises a sensor array. One non-limiting example of a suitable sensor is a Tekscan 5101 sensor array. In certain embodiments, the sensor is or comprises a thin film. Non-limiting examples of sensors are described in F. Schmaljohann, D. Hagedorn, and F. Löffler. “Thin Film Sensors for measuring small forces.” Journal of Sensors and Sensor Systems. No. 4. (February 2015), 91-95. In some cases, the sensor is commercially available and coupled to the electrochemical cell. However, in some cases, the sensor is fabricated during the manufacture of the electrochemical device. In some such cases, the sensor is formed by vacuum deposition, coating and curing (e.g., in the case of polymeric materials), printing (e.g., inkjet printing, screen-printing), and/or by spray methods (e.g., aerosol spray methods).

As mentioned above, in some embodiments, the sensor is a strain gauge. Strain gauges are devices whose resistance varies with applied force, thereby converting force (e.g., from applied pressure, tension, or weight) into electrical resistance which can then be measured. For example, a change in length of the strain gauge (e.g., due to tension or compression) can cause strain on a resistor that is part of the strain gauge, thereby changing the resistance of that resistor. It has been realized in the context of this disclosure that strain gauges can, in some instances, be readily integrated into assembled electrochemical devices due to their small size and facile incorporation with simple electrical circuitry. This ready integration of strain gauges stands in contrast with certain other equipment that can be used to measure force/pressure, such as external pressure testing equipment like an Instron® load frame pressure testing system or a hydraulic pressure testing system equipped with load cells. External pressure testing equipment are typically expensive and too bulky to be used with an assembled electrochemical device (e.g., battery) in normal use. Additionally, it has also been realized that strain gauges can have sufficient accuracy in measuring the expected pressure magnitudes and/or variations associated with the electrochemical devices of this disclosure. It has further been realized that strain gauges can achieve sufficient accuracy even without being in direct contact with the electrochemical cells or part of stacks of cells, as discussed in more detail below.

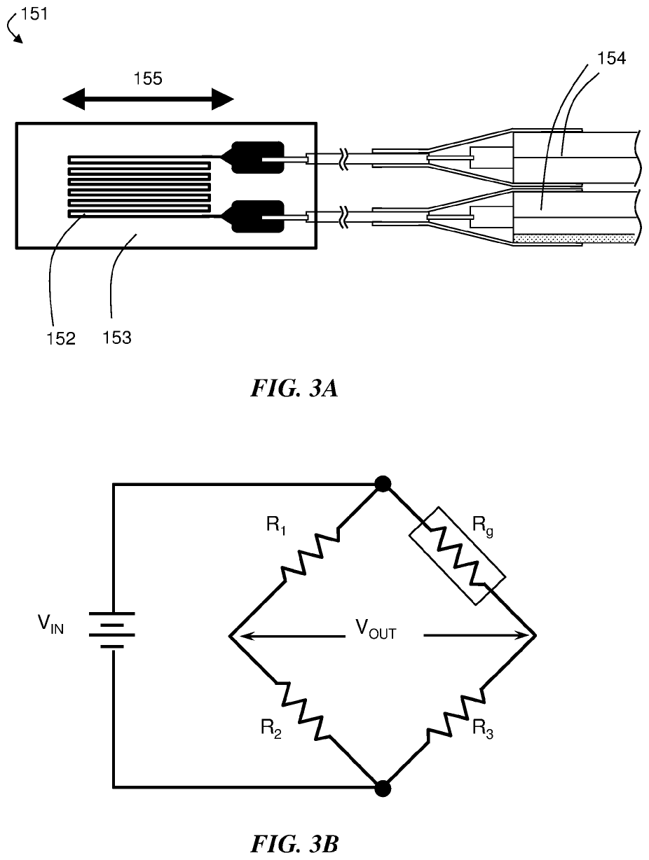

FIG. 3A shows a top view schematic illustration of strain gauge 151, which is one type of potential strain gauge suitable for use as the sensor. Strain gauge 151 comprises measuring grid 152 (e.g., comprising a metal and/or metal alloy of known resistivity such as Constantan) embedded in carrier 153 (e.g., a polymer carrier such as polyimide). Measuring grid 152 may be electronically coupled to leads 154 which can be used for measuring a signal associated with the strain gauge, such as a measured resistance, voltage, and/or electrical current. In use, strain 155 (shown as tension using arrows) can affect the measured resistance associated with measuring grid 152. Strain gauges of this type can be acquired commercially from vendors such as OMEGA® (Omega Engineering, Norwalk, CT).

In some embodiments, electrical circuitry is employed to determine an electrical signal from the sensor (e.g., a signal indicative of a pressure experienced by the electrochemical cell). For example, in some embodiments, a signal is produced from the sensor (e.g., a strain gauge) based on applied input voltage and a measured output voltage (which may in turn depend on a resistance of one or more components of the circuit). In some embodiments, a Wheatstone bridge circuit is employed as part of a strain gauge to produce a signal (e.g., a signal indicative of a pressure experienced by the electrochemical cell). FIG. 3B shows a circuit diagram on a Wheatstone bridge circuit, where Vᵢₙ is an input voltage, R₁, R₂, and R₃ are resistors of known and fixed resistance, R_{g} is the resistance of the strain gauge, and Vₒᵤₜ is an output voltage which can be measured using, for example, a galvanometer. In this configuration, Vₒᵤₜ is indicative of R_{g} based on Kirchhoff's circuit laws, and R_{g} varies based on force applied to the strain gauge, which, as discussed elsewhere in this disclosure, can depend on a magnitude of displacement of a component of the electrochemical device (e.g., a load-bearing housing component).

A measure of applied force, F, associated with a strain experienced by an object can be determined using a strain gauge coupled to the object by measuring Vᵢₙ when the strain gauge is unstrained and when it is strained (due to the applied force) using the following equations (1)-(4):

$${V}_{r} = [ {( \frac{{V}_{out}}{{V}_{in}} )}_{strained} - {( \frac{{V}_{out}}{{V}_{in}} )}_{unstrained} ] \qquad ( 1 )$$

$$ϵ = \frac{- 4 {V}_{r}}{GF ( 1 + 2 {V}_{r} )} \qquad ( 2 )$$

$$σ = E ϵ \qquad ( 3 )$$

$$F = σ A \qquad ( 4 )$$

where GF is the gauge factor, E is the Young's modulus of the object undergoing a change in dimension due to the strain (e.g., a load-bearing housing member as discussed below), and A is the cross-sectional area over which the measured strain is applied. Gauge factor is defined as the ratio of fractional change in electrical resistance to fractional change in length (strain) of the strain gauge. Gauge factor can be empirically determined for the particular strain gauge being used. The pressure experienced by an electrochemical cell at an electrode surface (e.g., an electrode active surface) can be determined by adding up the total force applied to the cell and dividing by the area of the electrode surface (e.g., the electrode active surface).

The sensor (e.g., a strain gauge, piezoelectric sensor, piezoresistive sensor) may be associated with the electrochemical device in any of a variety of ways. For example, in some embodiments, the sensor is attached to a component of the electrochemical device. For example, the sensor may be attached to a component of the electrochemical device using an adhesive and/or a fastener.

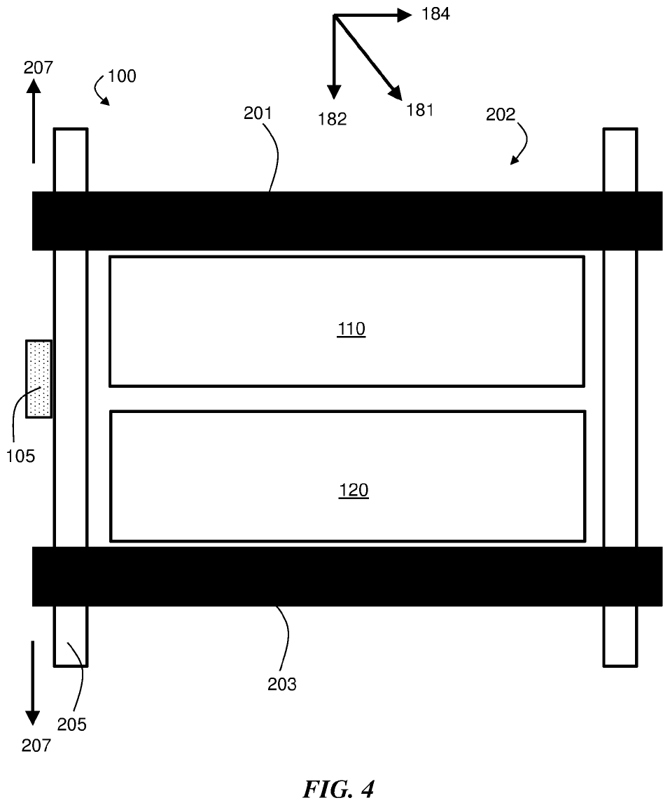

As noted above, in some embodiments, the electrochemical device comprises a housing. The housing may at least partially enclose other components of the electrochemical device. For example, the housing may at least partially enclose the electrochemical cell. FIGS. 1A-1B show housing 102 at least partially enclosing electrochemical cell 110, according to certain embodiments. FIG. 1C shows housing 102 at least partially enclosing stack 106 comprising first electrochemical cell 110 and second electrochemical cell 120. The housing may comprise rigid components. As one example, the housing may comprise one or more solid plates. For example, housing 202 in FIG. 4 comprises solid plate 201, according to some embodiments. In certain cases, the housing does not comprise a solid plate. For example, in some cases, the solid surfaces and other components of a containment structure of a housing configured to house the electrochemical cell are part of a unitary structure. In some embodiments, the housing is in the form of a frame coupled to solid plates (e.g., end plates) and has solid housing components covering lateral portions of the electrochemical cell.

In some embodiments, the housing of the electrochemical device is configured to apply, during at least one period of time during charge and/or discharge of the electrochemical cell, an anisotropic force having a relatively high magnitude component normal to electrode surfaces of at least one (or all) of the electrochemical cells in the electrochemical device. The housing may be configured to apply such a force in a variety of ways. For example, in some embodiments, the housing comprises two solid articles (e.g., a first solid plate and a second solid plate as shown in FIG. 4, where housing 202 comprises first solid plate 201 and second solid plate 203). An object (e.g., a machine screw, a nut, a spring, etc.) may be used to apply the force by applying pressure to the ends (or regions near the ends) of the housing. In the case of a machine screw, for example, the electrochemical cell and other components of the electrochemical device pack may be compressed between the plates (e.g., a first solid plate and a second solid plate) upon rotating the screw. As another example, in some embodiments, one or more wedges may be displaced between the housing and a fixed surface (e.g., a tabletop, etc.). The force may be applied by driving the wedge between the housing (e.g., between a solid plate of a containment structure of the housing) and the adjacent fixed surface through the application of force on the wedge (e.g., by turning a machine screw).

The housing may comprise couplings that can be used to connect components of the housing and/or apply at least a portion of the anisotropic force. The housing may comprise, for example, couplings proximate to the ends of the housing (e.g., proximate to the ends of the solid plates). FIG. 4 shows coupling 205 connecting first solid plate 201 and second solid plate 203, according to certain embodiments. A coupling may connect a first solid plate and a second solid plate. In some embodiments, the housing of the electrochemical device has more than one coupling. In certain cases, the housing includes at least 2 couplings, at least 4 couplings, and/or up to 8 couplings or more. In some embodiments, the coupling comprises a fastener. The fastener may span from one end of the housing to another. Examples of fasteners include, but are not limited to, a rod (e.g., a threaded rod, a rod with interlocking features), a bolt, a screw (e.g., a machine screw), a nail, a rivet, a tie, a clip (e.g., a side clip, a circlip), a band, or combinations thereof. In some cases, applying a force via a solid plate comprises causing relative motion between one portion of the coupling (e.g., a nut) and a fastener of the coupling (e.g., by tightening a nut at an interface between the fastener and the solid plate or, in cases where the fastener comprises a machine screw, by turning the machine screw).

In some embodiments, the housing of the electrochemical device is configured to apply the anisotropic force to an electrode surface via tension in a load-bearing housing member. In this context, the “load” of the term “load-bearing” refers to the load associated with the application of the anisotropic force having a component normal to the electrode surface of the electrochemical cell. It should be understood that a load-bearing housing member may experience a load associated with an entirety of the anisotropic force or just a portion of the anisotropic force (such as when there are multiple load-bearing housing members). For example, in FIGS. 1A-1B, housing 102 comprises load-bearing housing member 104 lateral to electrochemical cell 110, in accordance with some embodiments. In some instances, application of force 181 having component 182 normal to an electrode surface (e.g., an electrode active surface) of electrochemical cell 110 is accomplished by configuring housing 102 such that load-bearing housing member 104 is under tension. As another example, in FIG. 4, coupling 205 (e.g., a fastener such as a bolt) is a load-bearing housing member that is under tension in the direction of arrows 207 when used to press first plate 201 and second plate 203 against first electrochemical cell 110 and second electrochemical cell 120 such that an electrode surface (e.g., an electrode active surface) of first electrochemical cell 110 experiences a pressure defined by component 182 of anisotropic force 181. Coupling 205 is under tension because it maintains the position of first solid plate 201 and second solid plate 203 constraining first electrochemical cell 110 and second electrochemical cell 120. As yet another example, in FIG. 5, electrochemical device 100 comprises stack 304 comprising first electrochemical cell 110 and second electrochemical cell 120 at least partially enclosed by housing 302, which comprises first solid plate 310 and second solid plate 312 coupled to first solid housing component 314 and second solid housing component 316. Housing 302 may be in the form of a frame enclosing stack 304, with first solid housing component 314 and second solid housing component 316 being sides of the frame. Housing 302 may be configured such that application of anisotropic force 182 is maintained via tension in first solid housing component 314 and in second solid housing component 316 as first solid plate 310 and second solid plate 312 compress stack 304. Therefore, in this embodiment first solid housing component 314 and second solid housing component are load-bearing housing members of housing 302.

The load-bearing housing member can take any of a variety of forms depending on the design of the housing and technique used to apply the anisotropic force. In some embodiments, the load-bearing housing member is a solid body. In some embodiments, the load-bearing housing member is a rigid solid body. In some embodiments, the load-bearing housing member is a solid portion of the housing that spans the thickness direction of some or all electrochemical cells in the electrochemical device. In some embodiments, the load-bearing housing member is a coupling (e.g., a fastener such as a rod (e.g., a threaded rod, a rod with interlocking features), a bolt, a screw (e.g., a machine screw), a nail, a rivet, a tic, a clip (e.g., a side clip, a circlip), and/or a band). In some embodiments, the housing comprises a frame for at least partially enclosing the electrochemical cell (e.g., a containment structure) and the load-bearing housing member forms at least a portion of the frame (e.g., a portion of the frame lateral to the electrochemical cell when the electrochemical device is assembled).

In some embodiments, the load-bearing housing member undergoes a displacement along at least one dimension upon a change in magnitude of the applied anisotropic force. The sensor may be configured to produce a signal based on a magnitude of such a displacement and/or a component thereof. In some embodiments, the load-bearing housing member undergoes a displacement along a dimension having a component normal to the electrode surface of the electrochemical cell upon a change in magnitude of the applied anisotropic force. For example, an increase in magnitude of the applied force may be associated with the load-bearing housing member being under increased tension. The increased tension may then be associated with an elongation of the load-bearing housing member, resulting in a displacement of the load-bearing housing member in the tension direction having a component normal to the electrode surface. FIGS. 1A-1B illustrate such a phenomenon according to some embodiments. In FIG. 1A, housing 102 applies anisotropic force 181 with component 182 normal to an electrode surface of electrochemical 110 via tension in load-bearing housing member 104 having length 103. By contrast, in FIG. 1B, expansion of electrochemical cell 110 (e.g., due to deposition of anode active material such as lithium metal during charging) against rigid housing 102 may result in electrochemical cell 110 experiencing anisotropic force 181′ having component 182′ normal to the electrode surface of electrochemical cell 110, where component 182′ is greater than component 182 from FIG. 1A. The increased magnitude of component 182′ may be associated with an increased pressure experienced by electrochemical cell 110 and increased tension experienced by load-bearing housing member 104. The increased tension in load-bearing housing member 104 results in load-bearing housing member 104 undergoing a displacement having a component in a direction normal to the electrode surface of electrochemical cell 110, resulting in new length 103′, where new length 103′ in FIG. 1B is greater than length 103 from FIG. 1A. Analogously, a decrease in magnitude of an applied anisotropic force may be associated with the load-bearing housing member being under decreased tension and undergoing a displacement along a dimension having a component normal to the electrode surface in which the length of the load-bearing housing member contracts.

It has been realized in the context of this disclosure that displacement of the load-bearing housing member along a dimension having a component normal to the electrode surface can be indicative of a change in the magnitude of anisotropic force normal to the electrode surface and therefore the magnitude of pressure experienced by the electrode surface. Accordingly, it has been realized that measurement of such displacement of a component other than the electrochemical cell can indirectly produce a measurement of the pressure experienced by the electrochemical cell using the sensor rather than directly measuring the pressure at the electrochemical cell itself (e.g., by locating the sensor at the cell and subjecting the sensor to the anisotropic force). Therefore, in some embodiments, the sensor is configured to produce a signal (e.g., indicative of the pressure experienced by the electrode surface) at least in part based on a magnitude of displacement along a dimension of the load-bearing housing member having a component normal to the electrode surface. In some embodiments, the signal produced by the sensor is based on a measured voltage, current, and/or resistance that varies based at least in part on the magnitude of displacement along a dimension of load-bearing housing member having a component normal to the electrode surface. One example of a sensor that can be configured in such a way is a strain gauge. Displacement of the load-bearing housing member may cause a change in strain in the strain gauge, which may then produce a signal indicative of the magnitude of that displacement in the form of a change in measured resistance or voltage across the strain gauge. The change in measured resistance or voltage across the strain gauge may then be used to calculate a change in pressure experienced by the electrochemical cell (e.g., at the electrode surface). As another example, a piezoelectric or piezoresistive sensor may similarly be used to measure displacement along the load-bearing housing member and output a signal (e.g., electrical signal) indicative of that change.

In some, but not necessarily all embodiments, the sensor is adjacent to a load-bearing housing member. For example, in FIGS. 1A-1D, sensor 105 is adjacent to load-bearing housing member 104 of housing 102 at least partially enclosing electrochemical cell 110. Such a location of the sensor may facilitate the sensor measuring dimensional changes of the housing associated with the application of anisotropic forces to the electrochemical cell. In some embodiments, the sensor is directly adjacent to a load-bearing housing member. When the sensor is directly adjacent to the load-bearing housing member, no intervening components are between the sensor and the load-bearing housing member. In some embodiments, the sensor is attached to the load-bearing housing member. For example, the sensor may be attached to the load-bearing housing member via an adhesive, weld, and/or fastener. In some embodiments, the sensor is directly adjacent to an adhesive and/or a weld, which is in turn directly adjacent to the load-bearing housing member. In some embodiments, at least a portion of the sensor is within 10 mm, within 5 mm, within 2 mm, within 1 mm, within 0.5 mm, within 0.2 mm, within 0.1 mm, or less of at least a portion of a load-bearing housing member. In some embodiments, the sensor is located such that displacement of a load-bearing housing member along a dimension having a component normal to the electrode surface (e.g., electrode active surface) of the electrochemical cell causes the sensor to produce a signal indicative of the magnitude of the applied force causing the displacement and/or the pressure experienced by an electrode surface of the electrochemical cell as a result of the applied force. In some embodiments, the sensor is adjacent (e.g., directly adjacent) to an exterior surface of the housing (e.g., a load-bearing housing member). For example, in FIGS. 1A-1C, sensor 105 is exterior to housing 102 of electrochemical device 100. In other embodiments, the sensor is adjacent (e.g., directly adjacent) to an interior surface of the housing (e.g., a load-bearing housing member). For example, in FIG. 1D, sensor 105 is interior to housing 102 of electrochemical device 100.

In some embodiments, the sensor is lateral to the electrochemical cell. For example, in FIGS. 1A-1D, sensor 105 is lateral to electrochemical cell 110. In some embodiments where the electrochemical device comprises multiple electrochemical cells (e.g. part of a stack), the sensor is lateral to some or all of the electrochemical cells (e.g., is lateral to some or all of the stack). For example, in FIGS. 4-5, electrochemical device 100 comprises first electrochemical cell 110 and second electrochemical cell 120, and sensor 105 is lateral to both first electrochemical cell 110 and second electrochemical cell 120. A lateral positioning of the sensor may allow for simplicity of assembly of an electrochemical device comprising the electrochemical cell and the sensor (e.g., by separately assembling a stack of electrochemical cells and then coupling with a sensor during electrochemical device assembly). It has been realized in the context of this disclosure that a sensor can be located lateral to the electrochemical cell and still accurately produce a signal indicative of a magnitude of a pressure experienced by the electrochemical cell (e.g., by positioning the sensor adjacent to a load-bearing housing member). In some embodiments, the sensor is lateral to an electrode surface of the electrochemical cell. In some embodiments, the sensor is lateral to all electrode surfaces of a stack of electrochemical cells. In some embodiments, the sensor is lateral to an electrode active surface (e.g., an anode active surface and/or cathode active surface) of the electrochemical cell. In some embodiments, the sensor is lateral to all electrode active surfaces (e.g., an anode active surface and/or cathode active surface) of a stack of electrochemical cells. In some embodiments, at least 50 volume percent (vol %), at least 75 vol %, at least 90 vol %, at least 95 vol %, at least 99 vol % or all of sensor is lateral to at least 50 vol %, at least 75 vol %, at least 90 vol %, at least 95 vol %, at least 99 vol % or all of the electrochemical cell.

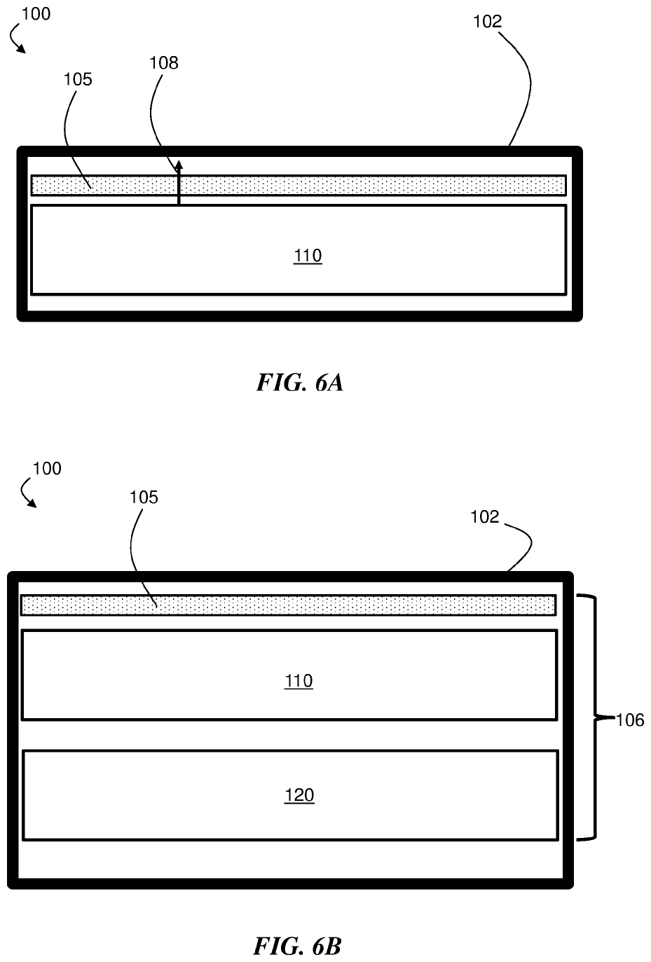

In some embodiments, the sensor is not lateral to the electrochemical cell. In some embodiments, the sensor overlaps the electrochemical cell such that there exists at least one line emanating perpendicularly from an electrode surface (e.g., an electrode active surface) of the electrochemical cell that intersects the sensor. For example, in FIG. 6A, sensor 105 overlaps electrochemical cell 110 such that line 108 perpendicular to an electrode surface of electrochemical cell 110 intersects sensor 105. In some embodiments, the sensor is at least partially (e.g. partially or completely) within a stack comprising the electrochemical cell. For example, in FIG. 6B, electrochemical device 100 comprises stack 106 comprising first electrochemical cell 110 and second electrochemical cell 120, and stack 106 further comprises sensor 105. In some such embodiments, the sensor may be at an end of the stack or may be an interior component of the stack (e.g., between electrochemical cells). Sensor arrays such as TEKSCAN pressure sensors may be usable as sensors that overlap electrode surface areas (e.g., electrode active surface areas) and/or are part of stacks of electrochemical cells.

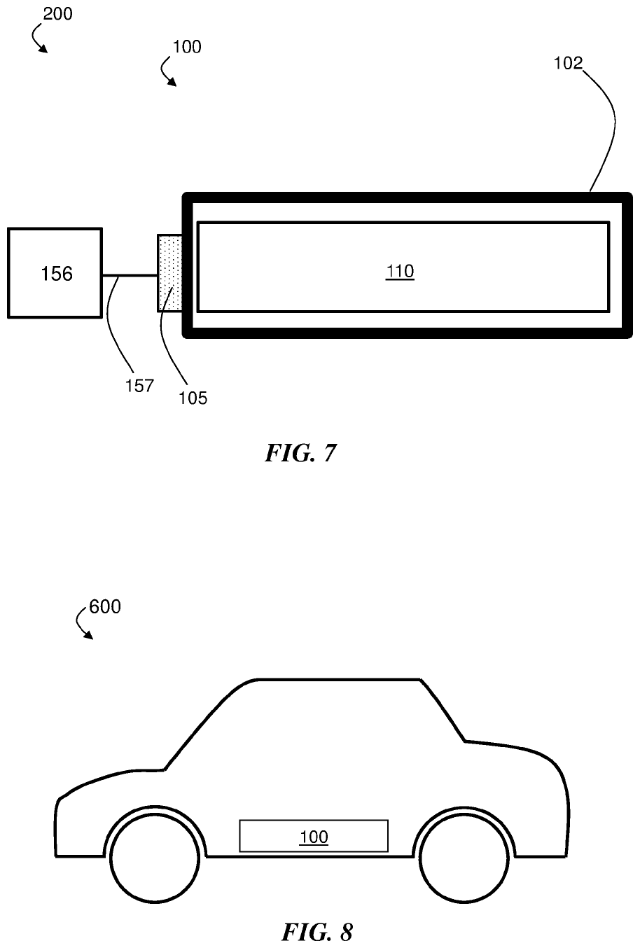

In some embodiments, the electrochemical device is part of a system configured to produce a signal indicative of a condition of the electrochemical cell in the electrochemical device. In some such embodiments, the signal indicative of a condition of the electrochemical cell is based at least in part on a measure indicative of the pressure experienced by the electrochemical cell (e.g., as a result of the applied anisotropic force). For example, in some embodiments the electrochemical device comprises or is coupled to a control system. The control system may be configured to receive a signal produced by the sensor. That signal produced by the sensor may be indicative of a measure of pressure experienced by the electrochemical cell. As an illustrative example, FIG. 7 shows a cross-sectional schematic diagram of system 200 comprising electrochemical device 100, sensor 105, and control system 156, in accordance with some embodiments. Sensor 105 may be configured to produce a signal indicative of a measure of pressure experienced by electrochemical cell 110, and control system 156 may be configured to receive that signal.

The control system can comprise one or more processors and/or management circuitry. The one or more processors may be configured to control and/or monitor one or more components of the electrochemical device, including from one or more (e.g., two or more, three or more, four or more) sensors (if present). Examples of suitable processors are described in more detail below.

The control system may be configured to receive an electrical signal from the sensor. For example, referring again to FIG. 7, system 200 may comprise control system 156 configured to receive an electrical signal from sensor 105 via wire(s) 157. While in some embodiments the control system is configured to receive a signal from the sensor via one or more wires or other solids, in other embodiments the control system is configured to receive a signal from the sensor wirelessly (e.g., where the sensor is equipped with a wireless transmitter such as a radio transmitter and the control system is equipped with a wireless receiver). The control system may comprise one or more processors programmed to determine a measure indicative of the pressure experienced by the electrochemical cell based at least in part on the signal produced by the sensor. One example of a process is as follows. Strain in the sensor (e.g., due to displacement of a load-bearing housing member) may result in a change in resistance or other property of the sensor, which may manifest in a change in measured voltage by a galvanometer coupled to an electrical circuit that includes the sensor. The voltage measured by the galvanometer may be transmitted (e.g., via wires or wirelessly) to the control system, where the voltage measurements may be stored in a computer's memory. Other parameters, such as empirical parameters related to components of the control system, pressure sensor, and electrochemical device may also be stored in the computer's memory (e.g., based on predetermined values programmed into the memory or values entered by a user). These parameters can include, but are not limited to resistances of resistors in a Wheatstone bridge circuit, a strain gauge's gauge factor (when the sensor is a strain gauge), and electrochemical device component dimensions (e.g., housing and electrode active area values). The one or more processors may be programmed to input these stored parameters and the measured output voltage into one or more equations from which a pressure experienced by the electrochemical cell can be calculated. For example, when the sensor is a strain gauge and a Wheatstone bridge circuit is used, the one or more processors may be programmed with instructions to input the stored and measured parameters into equations (1)-(4) described above to calculate the measured applied force associated with the sensor. The measured applied force may then be converted into a pressure measurement by dividing the total force experienced by the electrochemical cell by the electrode active area of the cell (a parameter that can stored in the memory of the computer).

As mentioned above, in some embodiments, a signal indicative of the condition of the electrochemical device is produced. The condition of the electrochemical device associated with the signal may be indicative of any of a variety of conditions relevant to the safe and/or effective operation of the electrochemical device. For example, in some embodiments, the signal indicative of the condition of the electrochemical device is indicative of the health and/or safety of the electrochemical device. For example, in some embodiments, the end of life of an electrochemical cell or a deleterious side reaction in the electrochemical cell may cause anomalous dimensional changes in the cell, which may consequently increase or decrease the pressure experienced by the electrode surface (e.g., the electrode active surface) due to force applied by a fixed housing. By monitoring the pressure experienced by the electrochemical cell (e.g., using the sensor and control system), such anomalous dimensional changes in the cell indicative of poor cell health and/or potential safety concerns from side reactions can be detected and addressed appropriately (e.g., by shutting down the cell from the electrochemical device's operation or modulating its charge and/or discharge rates). As another example, in some embodiments the utilization of the electrodes of the electrochemical cell is most efficient and/or current densities are highest when the electrode experiences an anisotropic pressure within a certain range. Incidental changes in pressure (e.g., due to external factors such as external handling of the electrochemical device or internal factors such as expansion/contraction of neighboring cells) may then reduce the efficiency of a cell. By monitoring the pressure experienced by the electrochemical cell (e.g., using the sensor and control system), deviations from desired applied pressures can be identified and addressed (e.g., by repositioning electrochemical device components and/or adjusting tension in load-bearing housing members).

The signal indicative of the condition of the electrochemical device may take any of a variety of forms. For example, the signal may be an electrical signal that is produced by the control system and sent via wires or wirelessly to a display of a separate computer (e.g., a user's computer) or a computer that is part of the same control system. The display may then be programmed to receive the signal and, based on the signal, display a message indicating information related to the condition of the electrochemical device. For example, the display may produce a diagnostic code. As another example, the signal may be an electrical signal that is produced by the control system and sent to one or more processors configured to modulate the operation of the electrochemical device. For example, in some embodiments, the control system comprises one or more processors programmed to initiate or cease charge and/or discharge or modulate the rate of charge and/or discharge of one or more electrochemical cells of the electrochemical device based on the electrical signal received by the processors that was indicative of the condition of the electrochemical device. As another example, in some embodiments the control system comprises one or more processors programmed to induce the electrochemical device to modulate the magnitude of anisotropic force applied to the electrochemical cell (e.g., by the housing) based on the electrical signal received by the processors that was indicative of the condition of the electrochemical device.

In some embodiments, the signal indicative of the condition of the electrochemical cell is based at least in part on whether the measure indicative of the pressure experienced by the electrochemical cell is greater than an upper threshold value or less than a lower threshold value. For example, one or more processors of the control system may be programmed to compare the measure indicative of the pressure experienced by the electrochemical cell as calculated above to an upper threshold value and/or a lower threshold value. The upper threshold and lower threshold values may be predetermined threshold values stored in a computer's memory or values entered manually by a user. In some embodiments, the one or more processors is programmed to produce the signal indicative of the condition of the cell if the measure of the pressure is greater than the upper threshold value. In some embodiments, the one or more processors is programmed to produce the signal indicative of the condition of the cell if the measure of the pressure is less than the lower threshold value. As a purely illustrative example, in some embodiments, a measured pressure experienced by the electrochemical cell (e.g., at an electrode surface) of greater than 50 kg_{f}/cm² is indicative of a deleterious side reaction in the cell that poses a safety concern, and a measured pressure experienced by the electrochemical cell of less than 5 kg_{f}/cm² is indicative of the cell being out of position with respect to pressure-applying components of the housing. In either case, production of a signal indicative of the measured pressure of the cell lying outside these respective upper and lower bounds can alert a user and/or an automated control system regarding the status of the cell and/or a need to intervene to address the electrochemical cell's condition. In some embodiments, in response to the signal indicative of the condition of the electrochemical device, the electrochemical device is configured to modulate an applied anisotropic force such that a signal indicative of the pressure experienced by the electrochemical cell (e.g., produced by the sensor) is less than or equal to the upper threshold value and greater than or equal to the lower threshold value. Such a process may be accomplished using a closed loop process involving the control system and, for example, the housing or pressure-applying components within the electrochemical device.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al₂O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂ (PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

In certain embodiments, the cathode active material comprises sulfur. In some embodiments, the cathode active material comprises electroactive sulfur-containing materials. “Electroactive sulfur-containing materials,” as used herein, refers to electrode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within an electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

Any of a variety of materials can be used as an electrolyte, in embodiments in which an electrolyte is present. The electrolyte can comprise, for example, a solution of ions, a solid electrolyte, a gel electrolyte, and/or a combination of these.

In some embodiments, the electrochemical cells further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known In the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

In the embodiments described herein, electrochemical devices may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

In some embodiments, the electrochemical device (e.g., a housing of the electrochemical device) is configured to apply, during at least one period of time during charge and/or discharge of the device, an anisotropic force with a component normal to an electrode surface (e.g., an electrode active surface) of one of the electrochemical cells (e.g., first electrochemical cell, second electrochemical cell).

In some embodiments, an anisotropic force with a component normal to an electrode surface of one of the electrochemical cells (e.g., first electrochemical cell, second electrochemical cell) is applied during at least one period of time during charge and/or discharge of the electrochemical device. In some embodiments, the force may be applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the electrochemical device. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the electrochemical device, but the magnitude of the forces in out-of-plane directions is substantially unequal to the magnitudes of the in-plane forces.

In one set of embodiments, electrochemical devices (e.g., housings) described herein are configured to apply, during at least one period of time during charge and/or discharge of the cell, an anisotropic force with a component normal to an electrode surface of one of the electrochemical cells (e.g., first electrochemical cell, second electrochemical cell). In such an arrangement, the electrochemical cell may be formed as part of a container which applies such a force by virtue of a “load” applied during or after assembly of the cell, or applied during use of the electrochemical device as a result of expansion and/or contraction of one or more components of the electrochemical device itself.

The magnitude of the applied force is, in some embodiments, large enough to enhance the performance of the electrochemical device. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean an electrochemical device that is identical, but where it is not constructed (e.g., by couplings such as brackets or other connections) to apply the anisotropic force on the subject electrochemical device.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may, in some but not necessarily all embodiments, be under an externally-applied anisotropic force with a component defining a pressure at least 10 kg_{f}/cm², at least 20 kg_{f}/cm², or more. This is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 10 kg_{f}/cm², at least about 20 kg_{f}/cm², and/or up 30 kg_{f}/cm², up to 40 kg_{f}/cm² of externally-applied pressure, the lithium surface may become smoother with cycling when the pressing surface is smooth.

In some cases, one or more forces applied to the cell have a component that is not normal to an electrode surface of an electrochemical cell (e.g., an anode). For example, in FIG. 1A force 184 is not normal to electrode surfaces of electrochemical cell. In one set of embodiments, the sum of the components of all applied anisotropic forces in a direction normal to any electrode surface of the electrochemical device is larger than any sum of components in a direction that is non-normal to the electrode surface. In some embodiments, the sum of the components of all applied anisotropic forces in a direction normal to any electrode surface of the electrochemical device is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode surface.

In some cases, electrochemical cells may be pre-compressed before they are inserted into housings, and, upon being inserted into the housing, they may expand to produce a net force on the electrochemical cells. Such an arrangement may be advantageous, for example, if the electrochemical cells are capable of withstanding relatively high variations in pressure.

In some embodiments, the electrochemical cells and electrochemical devices (e.g., batteries such as rechargeable batteries) described in this disclosure can be used to provide power to an electric vehicle or otherwise be incorporated into an electric vehicle. As a non-limiting example, electrochemical cells and/or electrochemical devices and/or batteries described in this disclosure (e.g., comprising lithium metal and/or lithium alloy electrochemical cells and/or sensors) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. FIG. 8 shows a cross-sectional schematic diagram of electric vehicle 600 in the form of an automobile comprising electrochemical device 100, in accordance with some embodiments. Electrochemical device 100 can, in some instances, provide power to a drive train of electric vehicle 600.

As described above, certain embodiments of the inventive systems and/or methods include one or more processors, for example, associated with a control system configured to receive the signal produced by the sensor. The processor may be part of, according to certain embodiments, a computer-implemented control system. The computer-implemented control system can be used to operate various components of the system. In general, any calculation methods, steps, simulations, algorithms, systems, and system elements described herein may be implemented and/or controlled using one or more computer-implemented control system(s), such as the various embodiments of computer-implemented systems described below. The methods, steps, control systems, and control system elements described herein are not limited in their implementation to any specific computer system described herein, as many other different machines may be used.

The computer-implemented control system can be part of or coupled in operative association with one or more articles (e.g., electrochemical cells, an electrochemical device housing, sensors) and/or other system components that might be automated, and, in some embodiments, is configured and/or programmed to control and adjust operational parameters, as well as analyze and calculate values, for example any of the values described above. In some embodiments, the computer-implemented control system(s) can send and receive reference signals to set and/or control operating parameters of system apparatus. In other embodiments, the computer-implemented system(s) can be separate from and/or remotely located with respect to the other system components and may be configured to receive data from one or more inventive systems via indirect and/or portable means, such as via portable electronic data storage devices, such as magnetic disks, or via communication over a computer network, such as the Internet or a local intranet.

The computer-implemented control system(s) may include several known components and circuitry, including a processor, a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

The computer-implemented control system(s) may include a processor, for example, a commercially available processor such as one of the series x86; Celeron, Pentium, and Core processors, available from Intel; similar devices from AMD and Cyrix; the 680X0 series microprocessors available from Motorola; and the PowerPC microprocessor from IBM. Many other processors are available, and the computer system is not limited to a particular processor.

A processor typically executes a program called an operating system, of which WindowsNT, Windows95 or 98, Windows XP, Windows Vista, Windows 7, Windows 10, Windows 11, UNIX, Linux, DOS, VMS, MacOS, OS8, and OS X are examples, which controls the execution of other computer programs and provides scheduling, debugging, input/output control, accounting, compilation, storage assignment, data management and memory management, communication control and related services. The processor and operating system together define, in accordance with certain embodiments, a computer platform for which application programs in high-level programming languages are written. The computer-implemented control system is not limited to a particular computer platform.

In accordance with certain embodiments, the processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer-implemented control system(s) that implements the methods, steps, systems control, and system elements control described above is not limited thereto. The computer-implemented control system(s) is not limited to a particular memory system.

At least part of such a memory system described above may be used to store one or more data structures (e.g., look-up tables) or equations such as calibration curve equations. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

It should be appreciated that one or more of any type of computer-implemented control system may be used to implement various embodiments described herein. Aspects of the invention may be implemented in software, hardware or firmware, or any combination thereof. The computer-implemented control system(s) may include specially programmed, special purpose hardware, for example, an application-specific integrated circuit (ASIC). Such special-purpose hardware may be configured to implement one or more of the methods, steps, algorithms, systems control, and/or system elements control described above as part of the computer-implemented control system(s) described above or as an independent component.

The computer-implemented control system(s) and components thereof may be programmable using any of a variety of one or more suitable computer programming languages. In addition, the methods, steps, algorithms, systems control, and/or system elements control may be implemented using any of a variety of suitable programming languages. Such languages may include procedural programming languages, for example, LabView, C, Pascal, Fortran, and BASIC, object-oriented languages, for example, C++, Java, and Eiffel, and other languages, such as a scripting language or even assembly language. In some embodiments, the computer programming language is Python. In some embodiments, the computer programming language is SQL.

Such methods, steps, algorithms, systems control, and/or system elements control, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product may comprise computer-readable signals tangibly embodied on the computer-readable medium that define instructions, for example, as part of one or more programs, that, as a result of being executed by a computer, instruct the computer to perform the method, step, algorithm, system control, and/or system element control.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21, 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. Patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”. U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”. U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; International Application Publication No. WO2021/183858 published on Sep. 16, 2021, filed as International Application No. PCT/US2021/022070 on Mar. 12, 2021 and entitled “APPLICATION OF PRESSURE TO ELECTROCHEMICAL DEVICES INCLUDING DEFORMABLE SOLIDS, AND RELATED SYSTEMS”.

U.S. Provisional Application No. 63/223,663, filed on Jul. 20, 2021 and entitled “BATTERY PACK AND RELATED COMPONENTS AND METHODS” is incorporated herein by reference in its entirety for all purposes. U.S. Publication No. US-2022-0311081 published on Sep. 29, 2022, filed as U.S. application Ser. No. 17/702,971 on Mar. 24, 2022, and entitled “BATTERY PACK AND RELATED COMPONENTS AND METHODS” is incorporated herein by reference in its entirety for all purposes.

U.S. Provisional Patent Application No. 63/320,955, filed Mar. 17, 2022, and entitled, “Pressure-Monitoring For Electrochemical Cells and Related Devices and Systems,” is incorporated herein by reference in its entirety for all purposes.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

As used herein, a surface is said to be “facing” an object when a line extending normal to and away from the bulk of the material comprising the surface intersects the object. For example, a first surface and a second surface can be facing each other if a line normal to the first surface and extending away from the bulk of the material comprising the first surface intersects the second surface. A surface can be facing another object when it is in contact with the other object, or when one or more intermediate materials are positioned between the surface and the other object. For example, two surfaces that are facing each other can be in contact or can include one or more intermediate materials between them. In some instances, a surface and an object (e.g., another surface) facing each other are substantially parallel. In some embodiments, two surfaces can be substantially parallel if, for example, the maximum angle defined by the two planes is less than or equal to 10°, less than or equal to 5°, less than or equal to 2°, or less than or equal to 1°.

The following examples are intended to illustrate certain embodiments of the present invention, but do not exemplify the full scope of the invention.

### Example 1

This example describes experimentation demonstrating the suitability of a sensor adjacent to a load-bearing housing member for accurately measuring applied force. Specifically, the sensor was in the form of a strain gauge and the load-bearing housing member was in the form of a titanium bolt. An Instron® 5969 load frame pressure testing system equipped with a 50 kN load cell was used to apply force to the titanium bolt, and force measurements from the strain gauge on the titanium bolt were compared with measurements from the Instron® load frame's load cell.

An Omega® KFH-6-350-C1-11L3M3R strain gauge having a 350 Ohm resistance was obtained and attached to the titanium bolt with its strain gauge grid aligned with the direction of compression/tension being tested. Adhesive was applied to the back of the strain gauge and Kapton tape was used to control, align, and stick the strain gauge to the titanium bolt. The Kapton tape was removed, and the adhesive was allowed to cure for 24 hours. The strain gauge was connected to a Bridge Completion Module comprising circuit components that, with the strain gauge, established a Wheatstone bridge circuit as shown above in FIG. 3B. The Bridge Completion Module was connected to a voltmeter, which was used to measure output voltages. The output voltages from the strain gauge were calibrated to applied forces and a strain gauge-measured force was determined from that calibration.

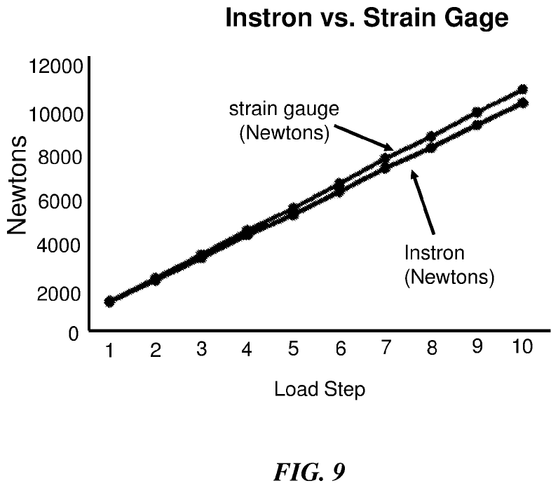

Ten load steps of increasing force were applied to the titanium bolt using the Instron® load frame with values ranging from 1000 Newtons to over 10,000 Newtons. FIG. 9 shows a plot of measured force data acquired during the load steps using the Instron® load frame's load cell (“Instron (Newtons)” on the plot) and using the strain gauge attached to the bolt (“Strain gauge (Newtons)” on the plot). The data in FIG. 9 demonstrate good agreement between the Instron® load frame pressure testing system and the strain gauge for over an order of magnitude of applied forces. This data indicates that a strain gauge on a load-bearing housing member of an electrochemical device can measure force (and therefore pressure) with adequate accuracy for electrochemical device pressure monitoring over a suitable dynamic range.

### Example 2

This example describes experimentation demonstrating the suitability of a sensor adjacent to a load-bearing housing member for accurately measuring applied force. Specifically, the sensor was in the form of a strain gauge and the load-bearing housing member was in the form of a carbon fiber coupon designed to form a longitudinal component of an electrochemical device housing frame in accordance with certain embodiments. The Instron® 68TM-50 load frame pressure testing system equipped with a 50 kN load cell was used to apply force to the carbon fiber coupon, and measurements from the strain gauge on the carbon fiber coupon were compared with measurements from the Instron® system's load cell.

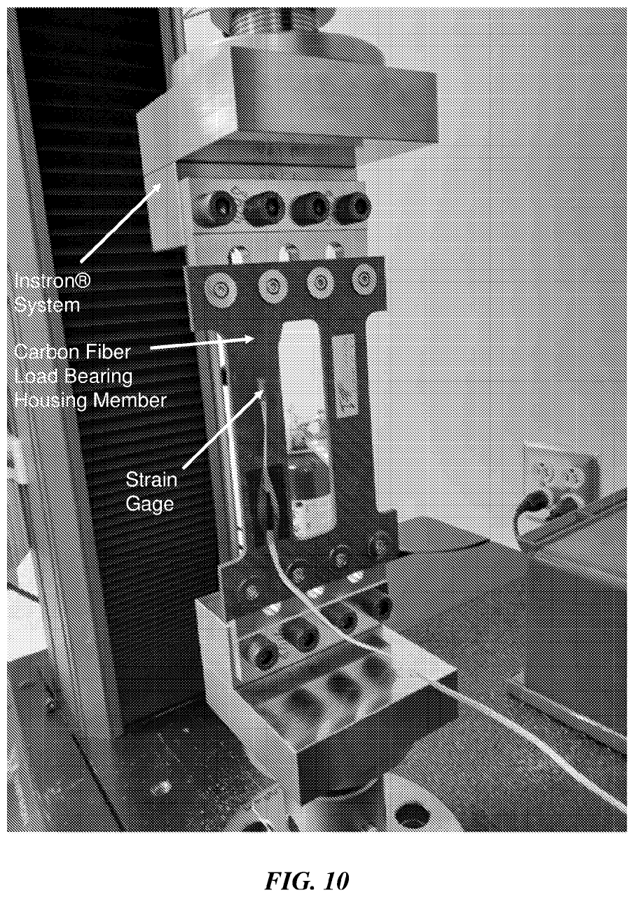

An Omega® KFH-6-350-C1-11L3M3R strain gauge having a 350 Ohm resistance was obtained and attached to carbon fiber coupon and strain gauge measurements were determined in the same manner described in Example 1 with respect to the titanium bolt using the output voltage measurements from a Wheatstone Bridge circuit. FIG. 10 shows an image of the experimental set-up, with a carbon fiber coupon with attached strain gauge situated in the Instron® pressure testing system.

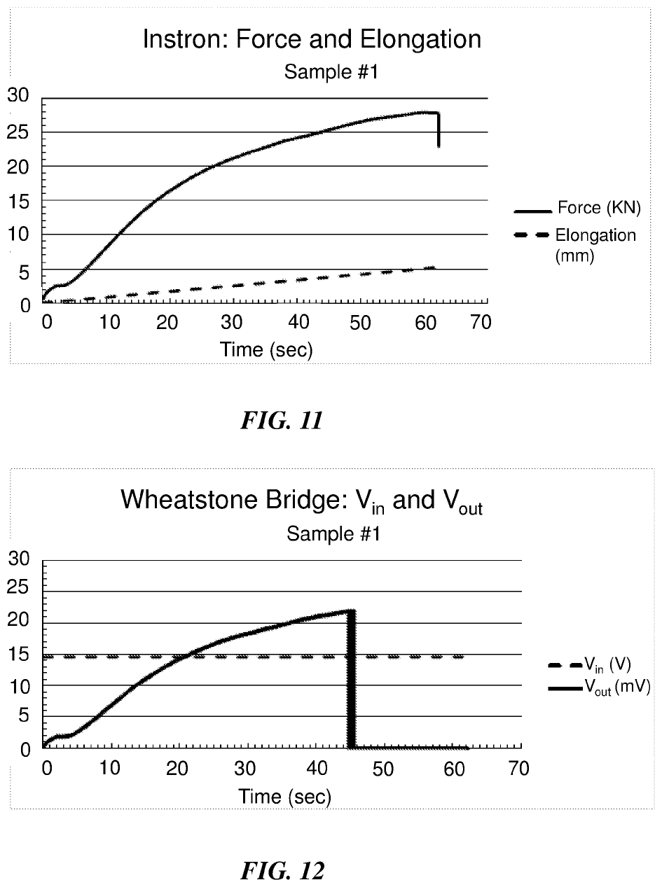

The load applied by the Instron® load frame system was ramped over a period of approximately one minute, and force and elongation measurements were measured using both the Instron® load frame, while at the same time the output voltage from the strain gauge (which correlates to force) were recorded. FIG. 11 shows plots of the force and elongation measurements recorded by the Instron® load frame, while FIG. 12 shows the output voltage Vₒᵤₜ from the strain gauge (along with the constant input voltage Vᵢₙ). The data in FIG. 11 and FIG. 12 indicate good agreement in measured force between the Instron® load frame and the strain gauge, and also demonstrates from the elongation measurements that the recorded force measurements are based at least in part on a magnitude of the displacement along the load-bearing dimension of the load-bearing housing member.

### Example 3

This example describes experimentation demonstrating the monitoring of pressure experienced by an electrochemical cell in an electrochemical device equipped with sensors adjacent to a load-bearing housing member of the electrochemical device during electrochemical device cycling. Specifically, strain gauge measurements were used to monitor pressure within an electrochemical device comprising a lithium metal anode-containing electrochemical cell within a housing. The housing was configured to apply pressure to the electrochemical cell via two carbon fiber end plates coupled via four titanium bolt fasteners as load-bearing housing members lateral to the cell. Two of the Omega® KFH-6-350-C1-11L3M3R strain gauges were attached to the titanium bolts and configured to provide force measurements in the manner described above in Example 1.

The force measurements from the strain gauges were converted to active area pressure measurements for the lithium anode of the electrochemical cell based on the cell and housing dimensions and calibration. Specifically, it was known that the electrochemical cell had an active area of 7280 mm², that there were four titanium bolts used as load-bearing housing members, each with a Young's modulus of 113800 MPa and a cross-sectional area of 19.635 mm². Each strain gauge had a gauge factor (GF) of 2.07, and an applied voltage of Vᵢₙ=5.25 V was used in the Wheatstone bridge circuit. The first strain gauge was determined to have an unstrained Vₒᵤₜ of 1.85 mV, while the second strain gauge was determined to have an unstrained Vₒᵤₜ of −0.15 mV. These values were used in conjunction with equations (1)-(4) above to calculate the applied anisotropic force and, consequently, the pressure experienced by the electrode active surface (because the geometry of the housing and the area of the electrode active surface were known).

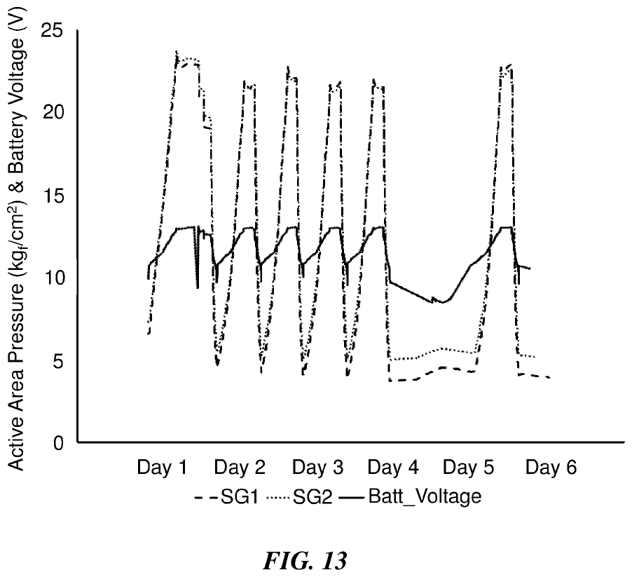

FIG. 13 shows a plot of electrochemical device voltage and active area pressure over time during cycling of the electrochemical device. Strain gauge measurements of the active area pressure are shown for the first and second strain gauge as “SG1” and “SG2”, respectively, and the electrochemical device voltage is shown as “Batt_Voltage.” The pressure experienced by the cell was expected to vary depending on the state of charge of the electrochemical device due to dimensional changes of the lithium metal anode based on the extent of lithium metal deposition. As can be seen in FIG. 13, the variation in active area pressure measured by the strain gauges on the titanium bolts agreed with the electrochemical device voltage over time. This indicates that the strain gauges on load-bearing housing members can be used to monitor pressure experienced by the cells (and variations thereof) in fully assembled electrochemical devices.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical device, comprising:
an electrochemical cell;
a housing at least partially enclosing the electrochemical cell, wherein the housing is configured to apply, via tension in a load-bearing housing member, during at least one period of time during charge and/or discharge of the electrochemical cell, an anisotropic force with a component normal to an electrode surface of the electrochemical cell; and
a sensor adjacent to the load-bearing housing member and configured to produce a signal indicative of a pressure experienced by the electrochemical cell.

2. A system, comprising:
an electrochemical cell;
a housing at least partially enclosing the electrochemical cell, wherein the housing is configured to apply, during at least one period of time during charge and/or discharge of the electrochemical cell, an anisotropic force with a component normal to an electrode surface of the electrochemical cell;
a sensor configured to produce a signal; and
a control system configured to receive the signal produced by the sensor, the control system comprising one or more processors programmed to:
determine a measure indicative of the pressure experienced by the electrochemical cell based at least in part on the signal produced by the sensor; and
produce a signal indicative of a condition of the electrochemical cell based at least in part on whether the measure indicative of the pressure experienced by the electrochemical cell is greater than an upper threshold value or less than a lower threshold value.

3. The electrochemical device of claim 1, wherein the component of the anisotropic force normal to an electrode surface of the electrochemical cell defines a pressure of at least 3 kg_{f}/cm².

4. The electrochemical device of claim 1, wherein the electrode surface is an electrode active surface.

5. The system of claim 2, wherein the housing is configured to apply the anisotropic force via tension in a load-bearing housing member.

6. The electrochemical device of claim 1, wherein the sensor is configured to produce the signal based at least in part on a magnitude of displacement along a dimension of the load-bearing housing member having a component normal to the electrode surface.

7. The electrochemical device of claim 1, wherein the sensor is directly adjacent to the load-bearing housing member.

8. The electrochemical device of claim 1, wherein the sensor is lateral to the electrochemical cell.

9. The electrochemical device of claim 1, wherein the signal produced by the sensor is based on a measured voltage, current, and/or resistance that varies based at least in part on the magnitude of displacement along a dimension of the load-bearing housing member having a component normal to the electrode surface.

10. The electrochemical device of claim 1, wherein the sensor comprises a strain gauge, a piezoelectric material, a load cell, and/or a pressure foam.

11. The electrochemical device of claim 1, wherein the sensor comprises a strain gauge.

12. The electrochemical device of claim 1, wherein the electrochemical cell is a first electrochemical cell, and wherein the electrochemical device comprises a stack of electrochemical cells at least partially enclosed by the housing, the stack comprising the first electrochemical cell and a second electrochemical cell.

13. The system of claim 2, wherein the signal indicative of a condition of the electrochemical cell is indicative of the health and/or safety of the electrochemical cell.

14. The system of claim 2, wherein, based on the signal indicative of the condition of the electrochemical cell, the one or more processors is programmed to initiate or cease charge and/or discharge or modulate the rate of charge and/or discharge of the electrochemical cell.

15. The system of claim 2, wherein, based on the signal indicative of the condition of the electrochemical cell, the one or more processors is programmed to induce the electrochemical device to modulate a magnitude of the anisotropic force applied to the electrochemical cell.

16. The electrochemical device of claim 1, wherein the electrochemical cell comprises lithium metal and/or a lithium alloy as an electrode active material during at least a portion of a charging and/or discharging process of the electrochemical cell.

17. (canceled)

18. The electrochemical device of claim 1, wherein the electrochemical device is a battery.

19. The electrochemical device of claim 18, wherein the battery is a rechargeable battery.

20. An electric vehicle, comprising the electrochemical device of claim 1.

21. A method, comprising:
applying, during at least one period of time during charge and/or discharge of an electrochemical cell, an anisotropic force with a component normal to an electrode surface of the electrochemical cell;
determining, during at least a portion of the applying step, a measure indicative of a pressure experienced by the electrochemical cell; and
producing a signal indicative of a condition of the electrochemical cell based at least in part on the measure indicative of the pressure experienced by the electrochemical cell.

22-43. (canceled)
